(19) United States
(12) Patent Application Publication
(10) Pub. No.: US 2019/0318219 A1
(43) Pub. Date: Oct. 17, 2019

(54) PERSONALIZED ARTIFICIAL INTELLIGENCE INTERACTIONS AND CUSTOMIZED RESPONSES OF A COMPUTER SYSTEM

(71) Applicant: INTERNATIONAL BUSINESS MACHINES CORPORATION, ARMONK, NY (US)

(72) Inventors: Pritpal Arora, Bangalore (IN); Dennis A. Perpetua, JR., Jay, NY (US); Jean Sabbouh, Palm Harbor, FL (US)

(21) Appl. No.: 15/950,409

(22) Filed: Apr. 11, 2018

(51) Int. Cl. G06N 3/00; G06F 17/30

(52) U.S. Cl. CPC G06N 3/006; H04L 67/10; G06F 17/30867

(57) ABSTRACT

A method, computer system, and a computer program product for customized responses is provided. The present invention may include connecting a user. The present invention may then include developing a system-aware user persona based on the connected user. The present invention may then include engaging in a user interaction. The present invention may lastly include generating a response to the user interaction based on the developed system-aware user persona and user interaction.

### BACKGROUND

The present invention relates generally to the field of computing, and more particularly to virtual assistants.

Current artificial intelligence bot solutions (e.g., virtual assistants) provide conversational capabilities based on knowledge repositories or pre-fed data, such as profile information of the individual the bot solution is interacting with. Contextual analysis by a bot solution may be limited to entity mappings and correlation of keywords to derive meaningful patterns, but may not predict the individual's sentiments based on context information.

### SUMMARY

Embodiments of the present invention disclose a method, computer system, and a computer program product for customized responses. The present invention may include connecting a user. The present invention may then include developing a system-aware user persona based on the connected user. The present invention may then include engaging in a user interaction. The present invention may lastly include generating a response to the user interaction based on the developed system-aware user persona and user interaction.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for customized responses according to at least one embodiment;

FIG. 3 is a block diagram of the customized response program according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for personalized artificial intelligence interactions and customized responses of a computer system. As such, the present embodiment has the capacity to improve the technical field of virtual assistants by personalizing an artificial intelligence interaction between a human and a computer system. More specifically, the present invention may include connecting a user. The present invention may then include developing a system-aware user persona based on the connected user. The present invention may then include engaging in a user interaction. The present invention may lastly include generating a response to the user interaction based on the developed system-aware user persona and user interaction.

As described previously, current artificial intelligence bot solutions (e.g., virtual assistants) provide conversational capabilities based on knowledge repositories or pre-fed data, such as profile information of the individual the bot solution is interacting with. Contextual analysis by a bot solution may be limited to entity mappings and correlation of keywords to derive meaningful patterns, but may not predict the individual's sentiments based on context information.

Therefore, it may be advantageous to, among other things, provide a means by which a bot solution may gauge a user's sentiment (e.g., whether the responses are temperamental, angry, disappointed, sad, happy, etc.) and may derive a user's persona based on the user's most recent online social interactions.

According to at least one embodiment, the customized response program may personalize an interaction between a human and a computer system (e.g., a bot solution utilizing artificial intelligence mechanisms and means).

According to at least one embodiment, the customized response program may detect a user type, as well as an attitude and behavior a user may have towards an online website, a brand, or a product, among many other things, within a targeted geographic area or online domain.

According to at least one embodiment, the customized response program may tailor an answer to a question posed by a user based on the user's area of business, job title, interests, hobbies, habits, personal details (e.g., marital status and/or number of children), geographic location, time of day, and assets owned, among many other considerations. Stores frequented by the user, locations in which the user spends time, technological devices used by the user, and sites frequented by the user, may also be considered by the customized response program. In tailoring a response to a question posed by a user, the customized response program may focus on an underlying reason (e.g., motivation) for the user's behavior and may communicate with the user more effectively.

According to at least one embodiment, the customized response program may detect changes in the speaking pattern and tone of voice of the user and, based on an analysis of the user's persona, the customized response program may appropriately match the user's tone of voice, emotion, speaking pattern and language.

According to at least one embodiment, when a user connects to the customized response program, the customized response program may gather details from connected enterprise systems, such as business unit or agency, assets owned, and job title, and may create a system-aware persona concerning the user. The customized response program may further capture historical information utilizing the user's digital footprint, to develop a more comprehensive picture of the user's behavior, personality, location (including physical and virtual locations) and interests. A persona manager within the customized response program may contain a tone analyzer which further determines whether prior responses of the user were made with similar emotion (e.g., a historical emotional awareness).

According to at least one embodiment, the customized response program may utilize natural language processing techniques to better understand the user's question, inquiry, or command, and to more accurately respond to the user.

According to at least one embodiment, the customized response program may utilize an answer service to categorize answers into response classifications, defined by relevant persona details. Persona details may include whether the user has an existing in-depth knowledge regarding the question domain, wherein a more sophisticated answer should be provided; whether the user's question suggests an answer tailored to the line of business, job title, or assets owned by the user; whether the user's question suggests an answer which takes into consideration the context of the situation, including geographic location and/or time of day, among other contextual factors; whether the user's question suggests an answer which includes relevant current events; and whether the user's question suggests an answer which has a modified tone of voice, style of speech, or rate of speech, based on a determined user emotion.

According to at least one embodiment, the utilized answer service may modify an answer to a user's question to ensure the interaction accurately responds to the user, given the user's determined personality (e.g., to encourage a natural and effortless interaction between the customized response program and the user).

According to at least one embodiment, the customized response program may be utilized in conjunction with Workplace Support Services with IBM's Watson™ (Watson and all Watson-based trademarks are trademarks or registered trademarks of International Business Machines Corporation in the United States, and/or other countries) SAAS solution, offering an enhanced personalized solution and enhanced contextual answers to questions posed by users of the customized response program.

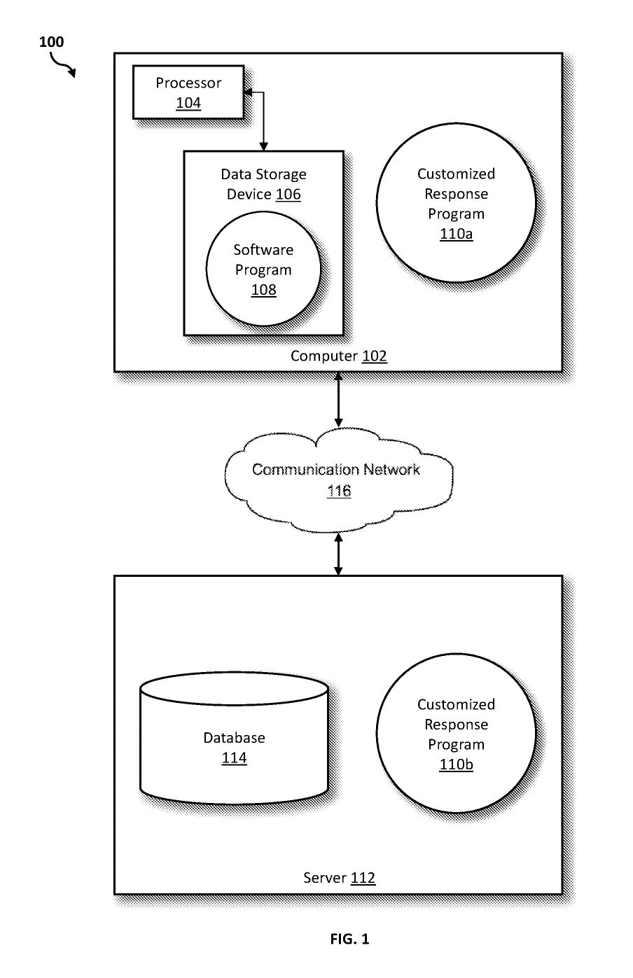

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a customized response program 110a. The networked computer environment 100 may also include a server 112 that is enabled to run a customized response program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

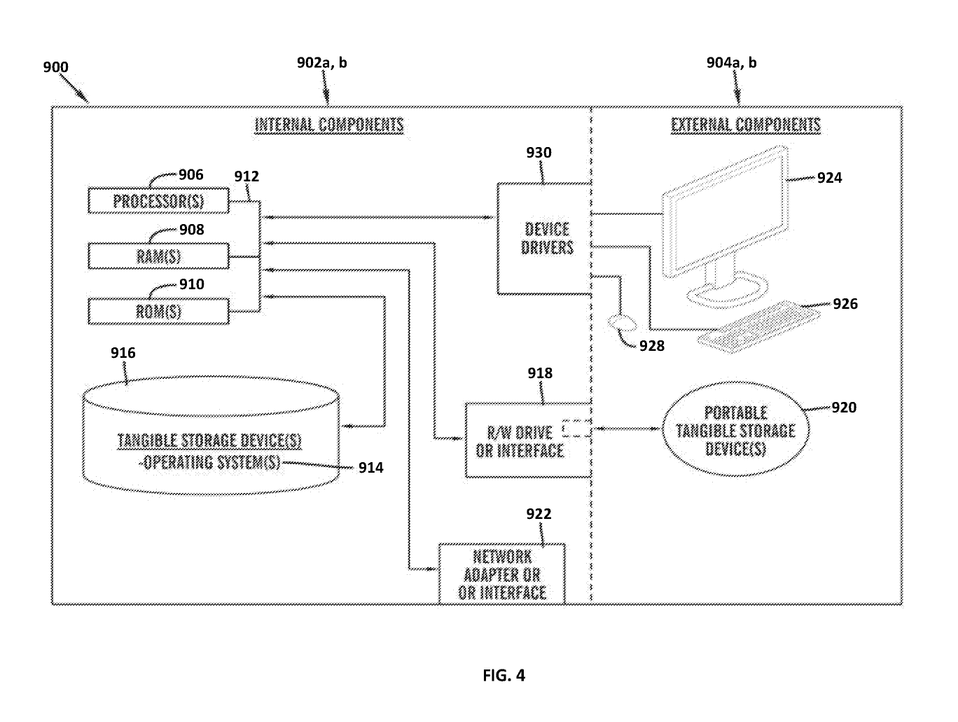

The client computer 102 may communicate with the server computer 112 via the communications network 116. The communications network 116 may include connections, such as wire, wireless communication links, or fiber optic cables. As will be discussed with reference to FIG. 4, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the customized response program 110a, 110b may interact with a database 114 that may be embedded in various storage devices, such as, but not limited to a computer/mobile device 102, a networked server 112, or a cloud storage service.

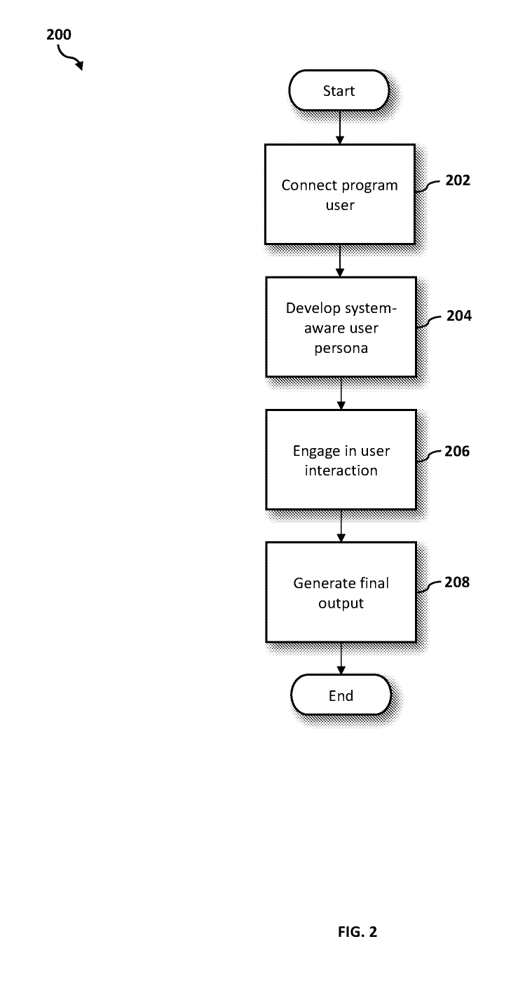

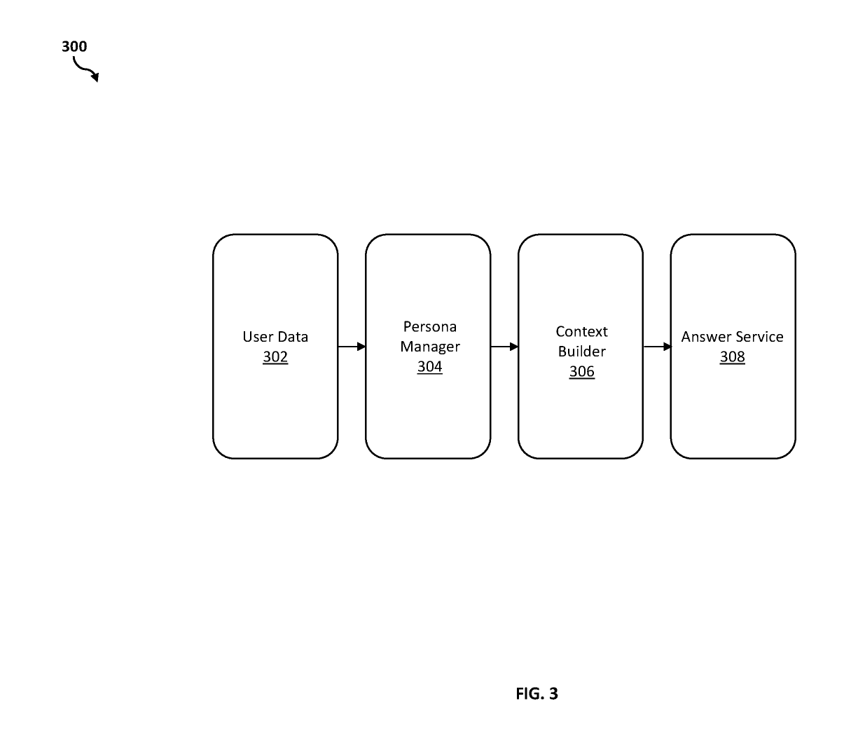

According to the present embodiment, a user using a client computer 102 or a server computer 112 may use the customized response program 110a, 110b (respectively) to personalize artificial intelligence interactions and customize responses of a computer system to a human based on historical data gathered concerning the program's user. The customized response method is explained in more detail below with respect to FIGS. 2 and 3.

Referring now to FIG. 2, an operational flowchart illustrating the exemplary customized response process 200 used by the customized response program 110a and 110b according to at least one embodiment is depicted.

At 202, the customized response program 110a, 110b connects to a user. A user may begin by connecting to the customized response program 110a, 110b (e.g., by loading the customized response program 110a, 110b website, by logging in to the customized response program 110a, 110b application, or by downloading or opening an application on the user's Information of Things (IoT) enabled mobile device or tablet which is running the customized response program 110a, 110b, among other means).

For example, John, a marketing executive at a global corporation, connects to the customized response program 110a, 110b by loading the customized response program 110a, 110b website on his tablet.

At 204, the customized response program 110a, 110b develops a system-aware user persona. Once connected to the user's profile, as described previously at 202, the customized response program 110a, 110b may access, based on defined user permissions within the customized response program 110a, 110b, the user's personal data, including but not limited to social media accounts, recently read news articles, and recent online purchases, among other things. The customized response program 110a, 110b may also access local user information, including calendar information, IP address, and Global Positioning System (GPS) location from the user's mobile device or tablet. Permissions (e.g., consent) to access information from a user's device may be given upon download of the customized response program 110a, 110b, and may be modified at any time within the customized response program's 110a, 110b interface.

The customized response program 110a, 110b may access relevant contextual information (e.g., persona details) to develop a system-aware user persona. The accessed information may assist in personalizing a response to a user inquiry, question, or command, as discussed in more detail below with respect to step 206. Persona details of a user (e.g., details that factor into the reasoning behind a user's question, inquiry, or command) may include enterprise employee data gathered from the user's connected enterprise employee systems and digital footprint data collected from the user's digital footprint (e.g., connected digital footprint systems), among other sources. Collected persona details may be analyzed by the customized response program 110a, 110b to determine the context and tone of the user's question, inquiry, or command.

Connected enterprise employee systems may include identity management services, asset management services, and human resources management services, among other enterprise employee services. Digital footprint services may include the user's Twitter™ feed, Instagram™ feed, news feed, and GPS location, among other connected digital services. Collected persona details, such as user interests and historical details, including those originating in enterprise employee systems and digital footprint systems, may be stored in a persona manager (e.g., persona database, or database 114). The persona manager may also include emotional patterns of the customized response program's 110a, 110b user, based on data from the user's social media accounts, recently read news articles, recent online purchases, and records from the user's employer, among other sources.

The persona manager may be accessed by the customized response program 110a, 110b when generating a response to a user question, inquiry, or command, as discussed in more detail below with respect to step 206.

Continuing with the above example, based on John's configured permissions, the customized response program 110a, 110b utilizes connected enterprise systems to gather information concerning John's location and specific job function. The customized response program 110a, 110b determines, based on the IP address of John's connected tablet, that John works out of the downtown Chicago office.

Continuing with the above example, the customized response program 110a, 110b discovers, based on John's recent social media activity, that John took his nephew to a Red Wings game last night and that John posted a picture of the outing on Instagram™. The customized response program 110a, 110b further discovers that John tweeted compassionately about a heartbreaking news story several weeks ago. John's Twitter™ feed includes more than one compassionate post, indicating to the customized response program 110a, 110b that John has a high degree of social empathy.

Based on the information that John has made available to the public, the customized response program 110a, 110b develops a system-aware online persona for John, which is based, in part, on data from John's social media accounts. John's online persona is also based on data from John's connected enterprise employee systems.

At 206, the customized response program 110a, 110b engages in user interaction. As described previously, a user may utilize an Information of Things (IoT) enabled handheld device, mobile device, or tablet to run the customized response program 110a, 110b. The user may speak (e.g., issue a question, an inquiry, or a command) into the customized response program 110a, 110b and the customized response program 110a, 110b may generate an answer in response. The generated answer may be based on data stored within the persona manager, as discussed previously at 204, including the tone used by the user, the user's determined interests, and any historical details relating to the user. The customized response program 110a, 110b may engage in a back-and-forth user interaction to clarify (e.g., by using a clarification service) and narrow down the context of the user's question before a final answer may be determined.

The customized response program 110a, 110b may utilize the clarification service to determine an appropriate response to provide to the customized response program's 110a, 110b user.

A response generated by the customized response program 110a, 110b may be outputted to the user in the same way that the user interaction was received (e.g., spoken aloud, or written in a chat box). A back-and-forth user interaction may be had until the customized response program 110a, 110b determines an appropriate response to the user's initial inquiry, question, or command.

Natural language processing technologies, such as Watson™ (Watson and all Watson-based trademarks are trademarks or registered trademarks of International Business Machines Corporation in the United States, and/or other countries) technologies, may be used by the customized response program 110a, 110b to analyze the user's question, inquiry, or command. The natural language processing technologies may include, but are not limited to, a natural language classifier API (e.g., Watson™ Natural Language Classifier API), a tone analyzer API (e.g., Watson™ Tone Analyzer API), and a personality insights API (e.g., Watson™ Personality Insights API).

Utilizing a natural language classifier API, such as Watson™ Natural Language Classifier API, the words used in the user's question, inquiry, or command may be analyzed to determine whether they are emotional (e.g., angry, sad, happy, anxious, funny, sarcastic, etc.), systematic, or inquisitive. During analysis of a written question, inquiry, or command, the Watson™ Natural Language Classifier API may consider the use of punctuation, including exclamation marks, as well as capital letters, to portray a classified emotion.

The tone analyzer API, such as Watson™ Tone Analyzer API, may utilize the gathered persona details, as discussed previously at 204, to determine whether the written question, inquiry, or command depicts a tone which is intense, lighthearted, serious, whimsical, or witty, among many other tones of voice.

The personality insights API, such as Watson™ Personality Insights API, may further utilize the gathered persona details to determine the user's general mood based on past interactions with the customized response program 110a, 110b, past use of emotional language, and past use of punctuation.

The customized response program 110a, 110b may modify a generated response based on a detected emotion of a user (e.g., the loud or soft tone of a user's voice, the rate of a user's speech, and the intensity of language used by a user). The customized response program 110a, 110b may gauge a user's temper based on recent and past social media interactions and may further modify a generated answer based on an interpreted user temper.

Continuing with the above example, John needs assistance fixing a broken printer. John opens the customized response program 110a, 110b on his IoT enabled tablet and speaks into his tablet. John says, “I need help fixing the stupid printer again.” The customized response program 110a, 110b utilizes information from John's developed online persona, as discussed previously at 204, including but not limited to his geographic location, to generate an appropriate response. The customized response program 110a, 110b responds to John by saying, “Hi John, sure, I am happy to help. I see four printers in the downtown Chicago office which are located near you. Is the problem you have with one of these four printers?” John replies again, indicating that this is the case. John speaks into his tablet, stating, “Yes, the same printer keeps breaking and it is really annoying me.”

At this point, the customized response program 110a, 110b asks John to describe the problem with more detail (e.g., by utilizing a clarifying service to determine the context of John's problem). John replies by indicating that only half of his email prints when he sends it to the printer. The customized response program 110a, 110b advises John that, because he is using Windows 7, a detail stored within John's persona manager, he must make sure that he has the latest drivers installed. The customized response program 110a, 110b follows up by emailing John links to the latest printer drivers, as the system has determined, based on John's online postings, that he is receptive to self-help, and further, since his online customized response program 110a, 110b profile indicates that email is John's preferred communication method for supplementary communication.

At 208, the customized response program 110a, 110b generates a final output. Continuing with the above example, John indicates to the customized response program 110a, 110b that the installation of new printer drivers is successful in remedying John's problem. The customized response program 110a, 110b responds by saying, “Great news John! Have a nice day and I hope you had a blast watching the Red Wings beat Anaheim last night!”

Referring now to FIG. 3, a block diagram 300 of the customized response program 110a, 110b according to at least one embodiment is depicted. As described previously at 202, a user may connect to the customized response program 110a, 110b, for example, by logging in to the customized response program 110a, 110b website, among many other ways. Once the user is connected to the customized response program 110a, 110b, user data 302 generated by connected enterprise employee systems and digital footprint services may be collected. As discussed previously at 204, enterprise employee systems may include identity management services, asset management services, and human resources management services, among other enterprise employee systems. Digital footprint services may include social media accounts, recent online purchases, GPS location, and configured online preferences, among many other digital footprint services. User data 302 may be collected and stored in a persona manager 304, which may include a record of all past and present customized response program 110a, 110b interactions, as well as collected data, as described previously at 204. The persona manager 304 may assist the context builder 306 in determining the context of the user's question, inquiry, or command. Based on the context builder's 306 determined context, the answer service 308 determines and issues an appropriate answer to the customized response program 110a, 110b user's question, inquiry, or command.

It may be appreciated that FIGS. 2 and 3 provide only an illustration of one embodiment and do not imply any limitations with regard to how different embodiments may be implemented. Many modifications to the depicted embodiment(s) may be made based on design and implementation requirements.

According to at least one other embodiment, the customized response program 110a, 110b may record the question, inquiry, or command issued by the user in the user's persona manager, and the customized response program 110a, 110b may follow up with the user on the status of the user's previous issue. For example, if the customized response program 110a, 110b assisted the user in resetting his or her password on Nov. 25, 2017, and the user's password is set to expire again on May 25, 2018, the customized response program 110a, 110b may send a message via the user's preferred communication method to advise the user that his/her password should be reset prior to May 25, 2018, so that it does not expire again.

FIG. 4 is a block diagram 900 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 4. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108 and the customized response program 110a in client computer 102, and the customized response program 110b in network server 112, may be stored on one or more computer-readable tangible storage devices 916 for execution by one or more processors 906 via one or more RAMs 908 (which typically include cache memory). In the embodiment illustrated in FIG. 4, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the customized response program 110a and 110b can be stored on one or more of the respective portable computer-readable tangible storage devices 920, read via the respective R/W drive or interface 918, and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the customized response program 110a in client computer 102 and the customized response program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the customized response program 110a in client computer 102 and the customized response program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

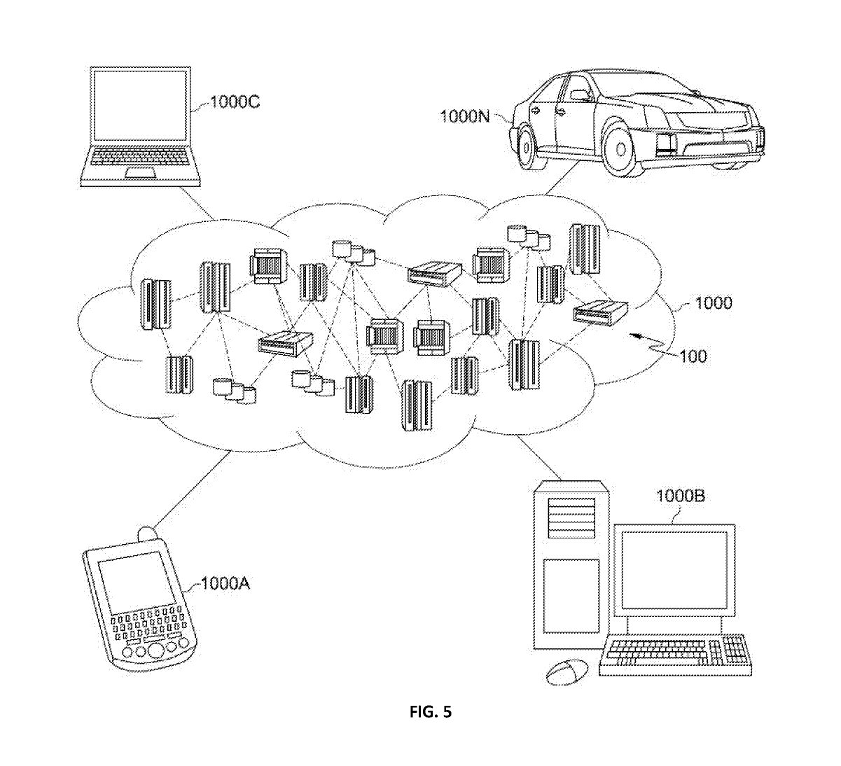

Referring now to FIG. 5, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 5 are intended to be illustrative only and that computing nodes 100 and cloud computing environment 1000 can communicate with any type of computerized device over any type of network and/or network addressable connection (e.g., using a web browser).

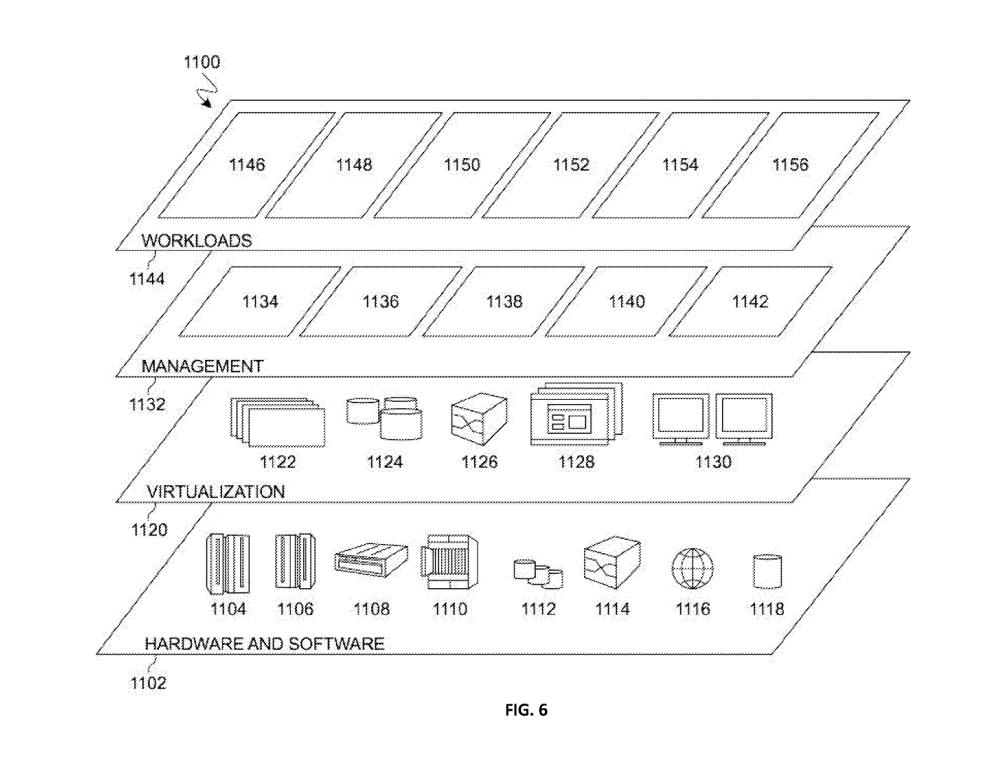

Referring now to FIG. 6, a set of functional abstraction layers 1100 provided by cloud computing environment 1000 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and customized response 1156. A customized response program 110a, 110b provides a way to personalize artificial intelligence interactions and customize responses of a computer system to a human based on historical data gathered concerning the program's user.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for customized responses, the method comprising:
connecting a user;
developing a system-aware user persona based on the connected user;
engaging in a user interaction; and
generating a response to the user interaction based on the developed system-aware user persona and user interaction.

2. The method of claim 1, wherein connecting the user is selected from the group consisting of loading a website, downloading an application, and opening an application.

3. The method of claim 1, wherein developing the system-aware user persona based on the connected user further comprises:
gathering a plurality of local user data;
accessing a connected enterprise employee system and a connected digital footprint system;
gathering a plurality of enterprise employee data from the connected enterprise employee system; and
gathering a plurality of digital footprint data from the connected digital footprint system.

4. The method of claim 3, wherein the plurality of local user data is selected from the group consisting of calendar data, IP address data, and global positioning system (GPS) data.

5. The method of claim 1, wherein the developed system-aware user persona is stored in a persona database.

6. The method of claim 1, wherein the user interaction is selected from the group consisting of a question, an inquiry, and a command.

7. The method of claim 1, wherein generating a response to the user interaction based on the developed system-aware user persona and user interaction further comprises:
determining a user context and a user emotion; and
issuing a response based on the determined user context and the determined user emotion.

8. A computer system for customized responses, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
connecting a user;
developing a system-aware user persona based on the connected user;
engaging in a user interaction; and
generating a response to the user interaction based on the developed system-aware user persona and user interaction.

9. The computer system of claim 8, wherein connecting the user is selected from the group consisting of loading a website, downloading an application, and opening an application.

10. The computer system of claim 8, wherein developing the system-aware user persona based on the connected user further comprises:
gathering a plurality of local user data;
accessing a connected enterprise employee system and a connected digital footprint system;
gathering a plurality of enterprise employee data from the connected enterprise employee system; and
gathering a plurality of digital footprint data from the connected digital footprint system.

11. The computer system of claim 10, wherein the plurality of local user data is selected from the group consisting of calendar data, IP address data, and global positioning system (GPS) data.

12. The computer system of claim 8, wherein the developed system-aware user persona is stored in a persona database.

13. The computer system of claim 8, wherein the user interaction is selected from the group consisting of a question, an inquiry, and a command.

14. The computer system of claim 8, wherein generating a response to the user interaction based on the developed system-aware user persona and user interaction further comprises:
determining a user context and a user emotion; and
issuing a response based on the determined user context and the determined user emotion.

15. A computer program product for customized responses, comprising:
one or more computer-readable storage media and program instructions stored on at least one of the one or more tangible storage media, the program instructions executable by a processor to cause the processor to perform a method comprising:
connecting a user;
developing a system-aware user persona based on the connected user;
engaging in a user interaction; and
generating a response to the user interaction based on the developed system-aware user persona and user interaction.

16. The computer program product of claim 15, wherein connecting the user is selected from the group consisting of loading a website, downloading an application, and opening an application.

17. The computer program product of claim 15, wherein developing the system-aware user persona based on the connected user further comprises:
gathering a plurality of local user data;
accessing a connected enterprise employee system and a connected digital footprint system;
gathering a plurality of enterprise employee data from the connected enterprise employee system; and
gathering a plurality of digital footprint data from the connected digital footprint system.

18. The computer program product of claim 17, wherein the plurality of local user data is selected from the group consisting of calendar data, IP address data, and global positioning system (GPS) data.

19. The computer program product of claim 15, wherein the developed system-aware user persona is stored in a persona database.

20. The computer program product of claim 15, wherein generating a response to the user interaction based on the developed system-aware user persona and user interaction further comprises:
determining a user context and a user emotion; and
issuing a response based on the determined user context and the determined user emotion.
